(19) United States
(12) Patent Application Publication
(10) Pub. No.: US 2019/0277084 A1
(43) Pub. Date: Sep. 12, 2019

(54) Finger Guard Device and Mounting Profile Therefor

(71) Applicant: Planet GDZ AG, Tagelswangen (CH)

(72) Inventors: Andreas Dintheer, Illnau (CH); Andreas Brändle, Hettlingen (CH)

(21) Appl. No.: 16/347,290

(22) PCT Filed: Oct. 9, 2017
(86) PCT No.: PCT/EP2017/075603

§ 371 Date: May 3, 2019

(30) Foreign Application Priority Data
Nov. 4, 2016 (DE) 20 2016 106 174.1

(51) Int. Cl. E06B 7/36

(52) U.S. Cl. CPC E06B 7/367

(57) ABSTRACT

A finger guard device for a pivotable leaf door has a roller screen housing, a roller screen web which has a fastening means, and a mounting profile. The finger guard device can be fastened to a door frame by means of the housing and to the leaf door by means of the mounting profile. The fastening means of the roller screen web can be connected detachably to the mounting profile so that the roller screen web covers a gap between the door leaf and the door frame when the finger guard device is used as intended. The mounting profile has a supporting leg for placing on and fastening to the door leaf. The mounting profile is in the form of an angled profile and has a fastening leg, which projects beyond the supporting leg, for detachably fastening the fastening means of the roller screen web.

### TECHNICAL FIELD

The present invention relates to a finger guard device for a pivotable leaf door and to a mounting profile therefor.

### PRIOR ART

Doors carry an increased risk of accidents, in particular for small children. Fingers are frequently trapped between the pivotable door leaf and the door frame. The forces acting on the trapped fingers are high, and accordingly the resulting injury may be serious.

The prior art has therefore disclosed devices which are intended to provide protection against unintentional trapping of the fingers. In one solution variant, the gap between the secondary closing edge of the pivotable door leaf on the opposing hinge side and the door frame is covered by a textile protective roller blind which is fastened, on the one hand, to the door frame and, on the other hand, to the pivotable door leaf.

Such a protective roller blind is disclosed, for example, in GB 2 164 690. The roller blind housing which contains a shaft for winding up the textile roller blind web is provided with a slot nut. A V-shaped holder, into which the slot nut can be plugged in order to hold the housing, is attached to the door frame. The free edge of the roller blind web is provided with a stiff end strip which is screwed to the door leaf. It is therefore possible for just the housing, but not the end strip, to be easily released.

In DE 20 2008 016 094 U, manipulation by releasing the screw connections is intended to be prevented and the mounting is intended to be simplified. In this case, holders are therefore provided both on the door frame side and on the door leaf side, said holders being screwed to the door frame and to the door leaf. The housing of the roller blind and the free edge of the roller blind are arranged in fastening means which can be latched into said holders and cover the fastening screws. This device has the disadvantage that release of the connection is possible only with a special tool. In addition, there is the risk that the holder or the fastening means will be destroyed during the release.

Furthermore, a readjustment of the holders is no longer possible since the fastening means cover the screws with which the holders are securely screwed to the door leaf and to the frame.

DE 37 16 654 discloses a finger guard device with a roller blind, wherein the roller blind housing is screwed to the door frame. The free edge of the roller blind is held in a groove of a mounting profile which is screwed to the pivotable door leaf. So that the roller blind can be released, the screws therefore have to be undone and the entire mounting profile removed from the door leaf. In addition, this device has the disadvantage that the mounting profile requires a relatively large amount of space.

This is annoying particularly if the door leaf has a horizontally running handlebar. Such handlebars are attached additionally or alternatively to the door handles, for example in emergency exits, escape doors or doors accessible for wheelchairs. Depending on the area of use and function, said handlebars are referred to as panic bars, a push-bar or by different terms. Usually, the handlebars can be pushed downward and/or two parts of the handlebars can be pressed together in order to open the door leaves. The handlebars usually extend over a large region of the door width. They often expand over the entire width of the door leaf.

A further solution is disclosed in FIG. 2 attached to this description. There is a mounting profile 4′, also called fastening strip, here which is fastened on the door leaf F. The free end 20 of the roller blind 2 is connected to a hanging profile 3, also called hanging strip. The hanging profile 3 can be hung in an undercut of the mounting profile 4′ to thereby fasten the roller blind to the pivotable door leaf in an easily releasable manner. This device has the advantage that the roller blind can be released and re-fastened easily and without special tools, for example if the door leaf has to be taken off its hinges. However, it is disadvantageous that, in the case of doors with handlebars, the space for the mounting is often insufficient since usually there has to be a sufficient distance from the handlebar.

Since handlebars are already preassembled in the doors and finger guard device are attached subsequently, certain doors with handlebars moreover also cannot easily be retrofitted with the other finger guard devices described above.

### DISCLOSURE OF THE INVENTION

It is therefore an object of the invention to provide a finger guard device for a pivotable leaf door and a mounting profile therefor, which can be used even in the case of door leaves with handlebars.

This object is achieved by a finger guard device having the features as claimed in claim 1 and by a mounting profile having the features as claimed in claim 17.

The finger guard device according to the invention for a pivotable leaf door has a roller blind housing, a roller blind web with a fastening means, and a mounting profile. Said finger guard device is fastenable by means of the housing to a door frame and by means of the mounting profile to the leaf door. The fastening means of the roller blind web can be connected releasably to the mounting profile, and therefore, when the finger guard device is used as intended, the roller blind web covers a gap between the door leaf and the door frame. The mounting profile has a supporting leg for supporting it on, and fastening it to, the door leaf. According to the invention, the mounting profile is in the form of an angular profile and it has a fastening leg projecting to the supporting leg, for the releasable fastening of the fastening means of the roller blind web.

Due to the projecting fastening leg, the door-side fastening means of the finger guard device can be of relatively narrow design. There is sufficient space next to a handlebar which has already been fitted. This is important since the doors are supplied with handlebars and finger guard devices are usually attached to the door only retrospectively, often only years later.

The roller blind web can be fastened to the door leaf in a wide variety of ways. In particular, all of the abovementioned types of fastening can be used, for example screwing on or clipping in. However, the fastening means can preferably be hung in the fastening leg in order to fasten the roller blind web between door frame and door leaf. Due to the spring-loaded resetting force of the roller blind, the roller blind web is thereby tensioned. This solution uses the advantages of the embodiment according to FIG. 2; that is to say, the roller blind web is easily fastenable and re-releasable without special tools having to be used for this purpose and without individual parts possibly being damaged.

Preferably, the fastening means has a hanging hook and the mounting profile has a hook receptacle. This is a device which is simple to operate.

In a preferred embodiment, the fastening means has a substantially U-shaped cross section with a first leg, a second leg and a web connecting the two legs. The first leg serves for the hanging and the second leg is extended in relation to the first leg. The fastening means has an outwardly directed groove, the end strip being introduced in said groove. This facilitates the fastening of the roller blind web, is visually attractive and is minimized in terms of dimensions. This design can be seen in FIG. 2.

The fastening leg can run at any angle unequal to 0° with respect to the supporting leg. However, it preferably runs at least approximately perpendicularly to the supporting leg. This is a space-saving solution.

In a simple embodiment, the fastening leg is directly adjacent to the supporting leg.

An optimally space-saving solution is provided if the mounting profile has a connecting leg which connects the supporting leg and the fastening leg to each other. As a result, the mounting profile can be mounted even when there is very little, if any, space between the handlebar and door leaf edge. In such a case, the mounting profile can be used particularly also when a handlebar extends over the entire width of the door leaf.

The connecting leg is preferably arranged at an angle of greater than 90° with respect to the supporting leg and with respect to the fastening leg. The space ratios are optimally used particularly whenever the angle between connecting leg and supporting leg and the angle between connecting leg and fastening leg is in each case approximately 135°.

The mounting profile is preferably designed as a single piece and is preferably composed of metal, in particular aluminum, or of a plastic. In one embodiment, said mounting profile is formed in two pieces or in a plurality of pieces at least in a longitudinal extent. That is to say, said mounting profile extends from an upper region of the door leaf as far as the upper side of the handlebar in one piece and from the lower side of the handlebar into a lower region of the door leaf in a second piece. In cross section, the mounting profile is preferably also formed in one piece in this embodiment, i.e. the two pieces mentioned are each in one piece.

In a preferred embodiment, the fastening leg tapers toward its free end and forms a hook receptacle. This facilitates the hanging of the roller blind web or of the fastening means thereof.

The hook receptacle preferably forms a rectilinear, but thinner extension of the fastening leg. This facilitates the single-piece production and, by a corresponding design of the fastening leg, ensures a hanging which is as free from play as possible. Preferred features for the corresponding realization of the last-mentioned advantage are also specified below.

The free end of the hook receptacle preferably has a lug directed away from the supporting leg. Alternatively or additionally, a thicker part of the fastening leg forms a first stop surface and the hook receptacle forms a second stop surface for the fastening means. The fastening means preferably surrounds the hook receptacle. All of these features individually and in combination with one another prevent wobbling of the hung hanging profile.

In a preferred embodiment, the supporting leg is brought laterally with its free end surface up to the handlebar, possibly as far as the stop, and is subsequently fastened to the door leaf. In other embodiments, the supporting leg has at least one recess for receiving the handlebar fastened to the door leaf. Such a recess can also be made in the supporting leg in situ by a fitter. For this purpose, the supporting leg is preferably provided in such a manner that the recess in the leg can be knocked out, for example as a predetermined breaking point, or can be produced by milling or sawing.

Further embodiments are specified in the dependent claims.

### BRIEF DESCRIPTION OF THE DRAWINGS

Preferred embodiments of the invention will be described below with reference to the drawings which merely serve for explanation and should not be interpreted as limiting. In the drawings:

FIG. 1 shows a perspective view of a door with a finger guard device;

FIG. 2 shows a cross section through a part of a door with a finger guard device in an unclaimed embodiment;

FIG. 3 shows a cross section through a part of a door with a finger guard device in a first embodiment according to the invention;

FIG. 4 shows a cross section through a part of a door with a finger guard device in a second embodiment according to the invention;

FIG. 5 shows a perspective detail of the finger guard device according to FIG. 3;

FIG. 6 shows a perspective illustration of a mounting profile of the finger guard device according to FIG. 3;

FIG. 7 shows a cross section through the mounting profile according to FIG. 6, and

FIG. 8 shows a perspective detail of the finger guard device according to FIG. 4.

### DESCRIPTION OF PREFERRED EMBODIMENTS

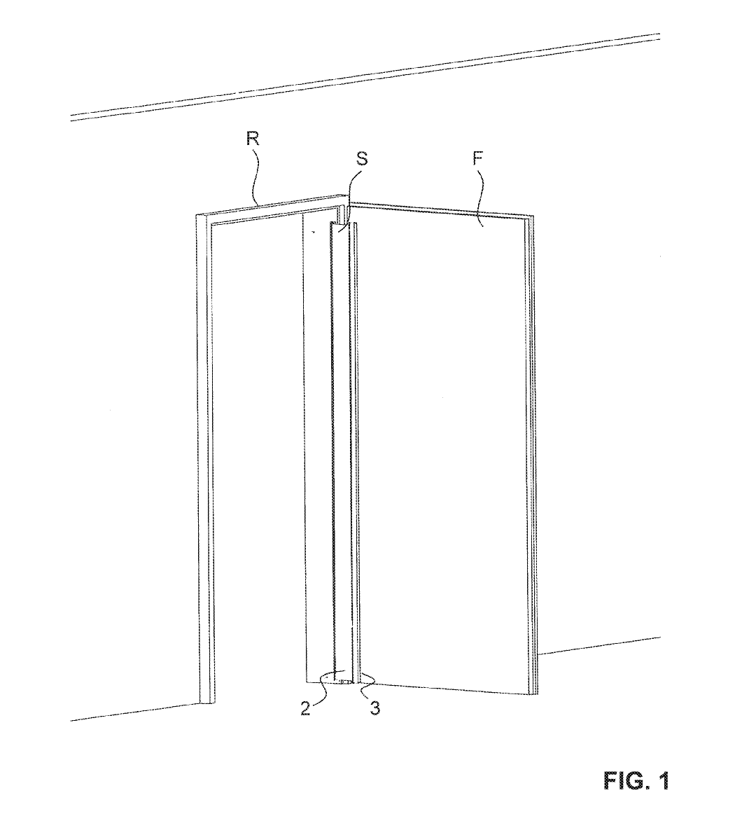

FIG. 1 illustrates the basic principle of a finger guard device, the principle also forming the basis for the device according to the invention. FIG. 1 shows a door with a door frame R and a door leaf F. In this figure, the door hinge is not visible. As can be seen in FIG. 1, the finger guard device S extends approximately over the entire height of the door leaf F and thus bridges the gap arising between door frame R and door leaf F when the door is open.

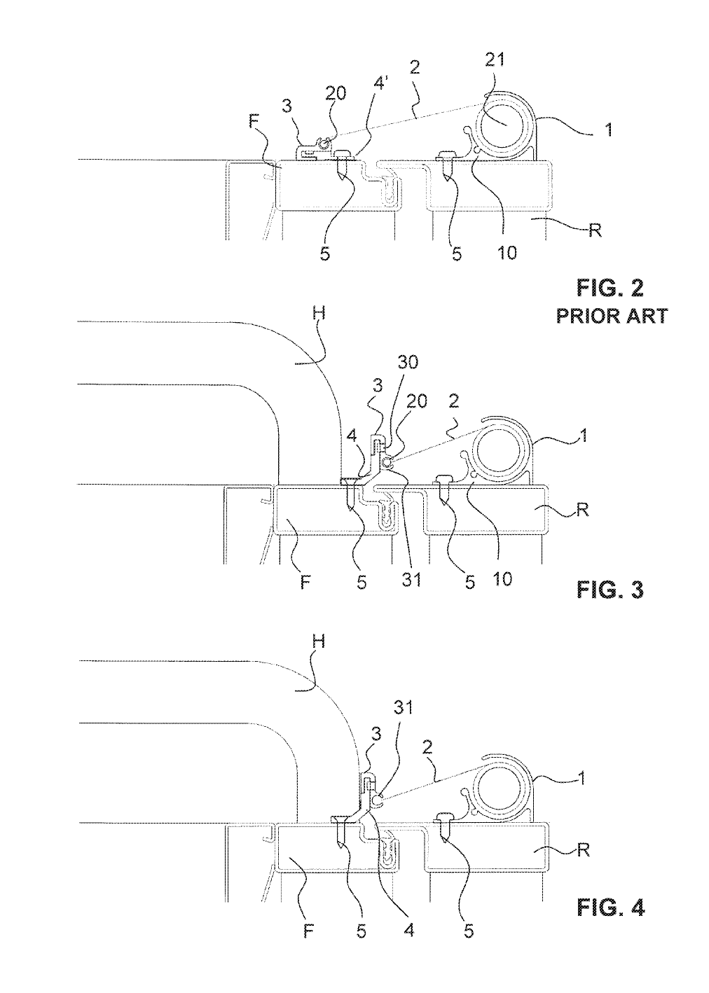

An embodiment of a finger guard device can readily be seen in FIG. 2. Said finger guard device substantially consists of a roller blind. A shaft 21 is arranged in a roller blind housing 1. A roller blind web 2 is wound on the shaft 21. The roller blind web 2 is preferably composed of a textile material. The shaft 21 is spring-loaded, and therefore an unwound part of the roller blind web 2 is automatically retracted.

The free end of the roller blind web 2 is reinforced with an end strip 20. Said end strip can be formed by thickening the roller blind web 2 or by a wire. Usually, however, the free edge of the roller blind web 2 is connected to a metal or plastic strip. Said end strip 20 is held in a hanging profile 3 which is of hook-shaped design.

The roller blind housing 1 of the roller blind is usually fastened to the door frame R. For this purpose, a fastening strip 10 is attached to the roller blind housing 1 or is connected in one piece thereto. A mounting profile 4′ is screwed to the counterpart of the door, i.e. here to the door frame R. The fastening screws are provided with the reference sign 5 in the figures.

The hanging profile 3 is hung in the mounting profile 4′ for the fastening of the roller blind. Due to the resetting force of the roller blind, in the hung state the roller blind web 2 is tensioned in every position of the door leaf F. Said roller blind web always covers the gap between door frame R and door leaf F.

The inventive embodiments according to FIGS. 3 to 8 use the same basic principle. In a first inventive embodiment according to FIGS. 3 and 5 to 7, instead of the mounting profile 4′ being flat, as per FIG. 2, a mounting profile 4 is, however, now designed as an angular profile. It is preferably formed in one piece and is preferably manufactured from metal or a plastic. It preferably extends over the entire width of the roller blind web 2, i.e. over approximately the entire height of the door leaf F.

The roller blind housing 1 and the hanging profile 3 can be formed identically as in the embodiment according to FIG. 2. The roller blind web 2 is held with its end strip 20 fixed in the hanging profile 3. For this purpose, the hanging profile 3 has a main body which has a substantially U-shaped cross section. A first leg of the U-shaped main body forms a hanging hook. A second leg of longer design has a groove 31 at its free end. Said groove is in the form of a support. The opening of the groove 31 is located on the side of the second leg opposite the hung hook, and is directed toward the roller blind housing 1. The groove 31 preferably extends over the entire length of the hanging profile 3. The hanging profile 3 is preferably the same length as the mounting profile 4 and as the roller blind housing 1. At least the hanging profile 3 and the groove 31 are the same length as the roller blind web 2. The end strip 20 is introduced into the groove 31 of the hanging profile 3. Said end strip is held pivotably therein.

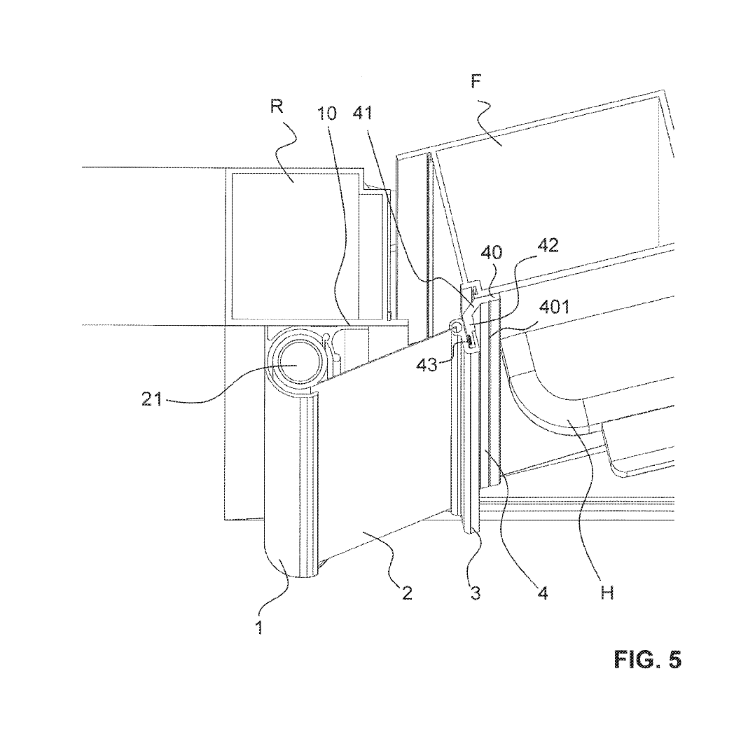

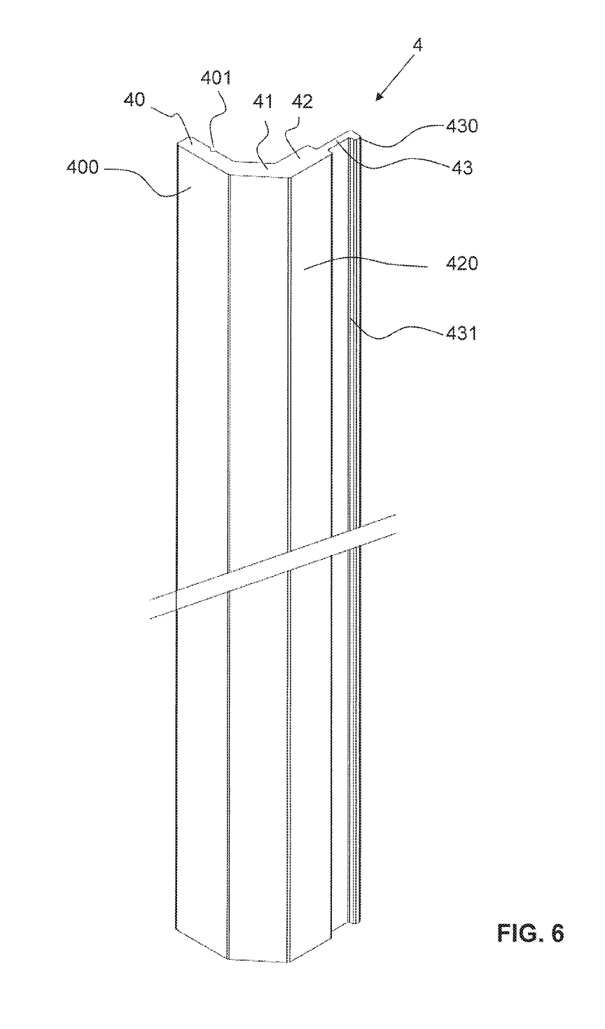

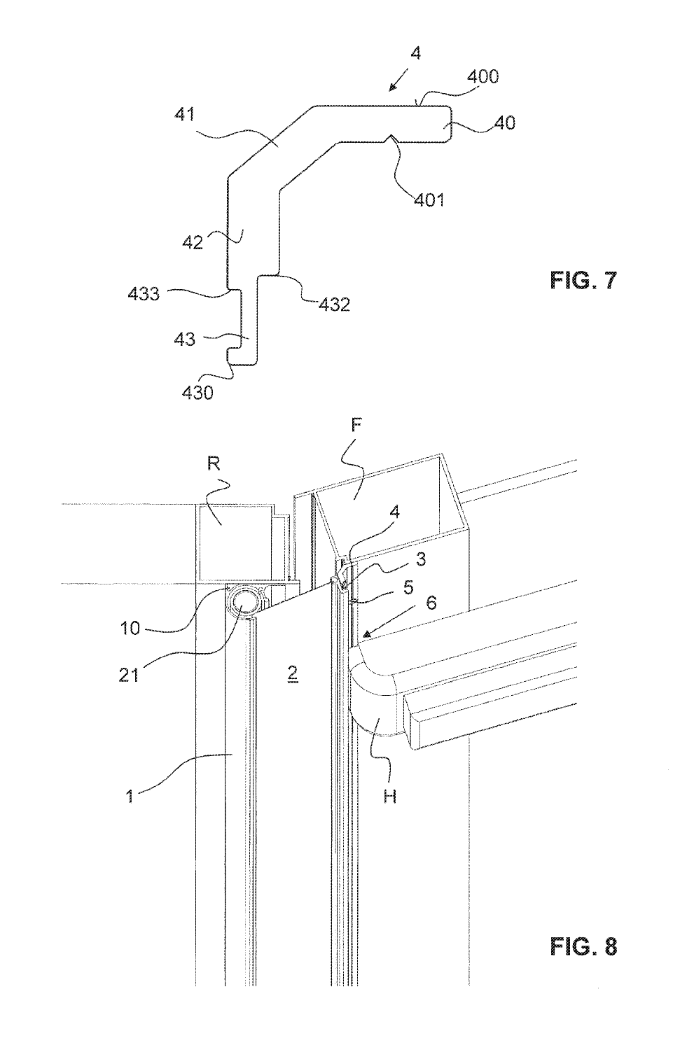

According to the invention, the mounting profile 4 is designed differently than in the embodiment according to FIG. 2. It has an angular profile. As can readily be seen in FIG. 5, it has a supporting leg 40 by which the mounting profile 4 lies against the door leaf, and is fastened to the door leaf F by means of screws 5 or other fastening means, e.g. by adhesive bonding. The supporting surface 400 by which the supporting leg 40 lies against the surface of the door leaf F can be seen in FIGS. 6 and 7.

The mounting profile 4 merges from the supporting leg 40 into a connecting leg 41 and from there into a fastening leg 42. The fastening leg 42 projects outward to the supporting leg 40, i.e. away from the door leaf surface. It preferably runs at least approximately at right angles to the supporting leg 40. The connecting leg 41 runs obliquely to the two remaining legs 40, 42 and therefore preferably forms an angle of greater than 90°. The angle is preferably approximately 135°.

The supporting leg 40 can be formed, for example, with plane-parallel surfaces, or it can have decorations and/or mounting aids, such as, for example, one or more grooves or slots 401, for example on the side facing outward away from the door leaf F. Said grooves or flutes preferably run in the longitudinal direction of the mounting profile 4.

The mounting profile 4 is formed with a constant cross section over its entire length. It is preferably an extruded profile. The supporting leg 40 and the connecting leg 41 are preferably identical in thickness. The fastening leg 42 is preferably thicker and tapers toward its free end. The fastening leg tapers here via two mutually opposite steps which are, however, arranged offset with respect to each other. The tapered part of the fastening profile 42 forms a hook receptacle 43 for the fastening means of the roller blind web 2, i.e. for the hanging profile 3.

As can readily be seen in FIG. 5, the hanging profile 43 lies with its second leg against a first stop surface 420 of the thicker part of the fastening leg 42. The stop surface 420 is indicated in FIG. 6. The hook of the hanging profile 3 engages around the free end of the hook receptacle 43 and the first, shorter leg of the hanging profile 43 lies against that surface of the thinner extension of the fastening leg 42 which faces away from the rolling blind housing 1. The free end of the shorter leg of the hanging profile 3 butts here against a shoulder between hook receptacle 43 and thicker part of the fastening leg 42. Said shoulder forms a second stop surface 432. A lug 430 facing the roller blind housing 1 is arranged at the free end of the hook receptacle. The lug 430 preferably forms a right angle with the rest of the hook receptacle 43. The lug 430 preferably extends into the plane which is defined by the first stop surface 420. The lug 430 together with the two stop surfaces 420, 432 mentioned prevents wobbling of the hung hanging profile 3. In addition, the hanging profile 3 can be fixed in said hung position by one or more screws 30.

The mounting profile 4 according to the invention permits hanging of the roller blind web 2 perpendicularly to the door surface. On the one hand, this facilitates the hanging. However, the substantial advantage is that the mounting profile 4 requires relatively little space and can therefore also be arranged next to an existing handlebar H of a door. This can readily be seen in FIGS. 3 and 5.

If the space between door leaf edge and handlebar H is even more limited, the handlebar H extends over the entire width of the door leaf as far as the door leaf edge or if such an arrangement is desired for other reasons, a solution according to FIGS. 4 and 8 can be selected. The contact leg 40 of the mounting profile 4 is provided with a recess 6 in which the end of the handlebar H engages. The recess 6 can extend as far as the connecting leg 41 or even as far as the fastening leg 42.

The recess 6 can be provided at the factory. However, it can also be produced at a suitable point in situ by the fitter, for example by milling or by sawing. It can also be pretreated at the factory as a predetermined breaking point.

In an embodiment not illustrated here, the mounting profile 4 is also divided into two pieces arranged above and below the handlebar H. The fastening strip 20 and the roller blind web 2 are formed in one piece and therefore also extend over that region of the handlebar H which separates the two pieces of the mounting profile 4 from each other.

The finger guard device according to the invention and the mounting profile according to the invention permit the use of a finger guard device even in the case of door leaves with handlebars.

LIST OF REFERENCE SIGNS

| | |
|---|---|
| 1 | Roller blind housing |
| 10 | Fastening strip |
| 2 | Roller blind web |
| 20 | End strip |
| 21 | Shaft |
| 3 | Fastening means (hanging profile) |
| 30 | Screw |
| 31 | Groove |
| 4 | Mounting profile |
| 4′ | Mounting profile |
| 40 | Supporting leg |
| 400 | Supporting surface |
| 401 | Slot |
| 41 | Connecting leg |
| 42 | Fastening leg |
| 420 | First stop surface |
| 43 | Hook receptacle |
| 430 | Lug |
| 431 | Slot |
| 432 | Second stop surface |
| 433 | Shoulder |
| 5 | Screw |
| 6 | Recess |
| R | Door frame |
| F | Door leaf |
| H | Handlebar |
| S | Finger guard device |

1. A finger guard device for a pivotable leaf door, the finger guard device comprising:
a roller blind housing,
a roller blind web with a fastening means, and
a mounting profile,
wherein the finger guard device is fastenable by the roller blind housing to a door frame and by the mounting profile to the leaf door,
wherein the fastening means of the roller blind web is releasably connectable to the mounting profile such that the roller blind web covers a gap between the door leaf and the door frame,
wherein the mounting profile has a supporting leg for supporting the mounting profile on and fastening the mounting profile to the door leaf, and
wherein the mounting profile is in the form of an angular profile and has a fastening leg projecting to the supporting leg, for the releasable fastening of the fastening means of the roller blind web.

2. The finger guard device as claimed in claim 1, wherein the fastening means is configured to be hung in the fastening leg to fasten the roller blind web between the door frame and the door leaf.

3. The finger guard device as claimed in claim 2, wherein the fastening means has a hanging hook and the mounting profile has a hook receptacle.

4. The finger guard device as claimed in claim 1, wherein the fastening means has a substantially U-shaped cross section with a first leg, a second leg, and a web connecting the two legs, wherein the first leg serves for the hanging and the second leg is extended in relation to the first leg and has an outwardly directed groove, an end strip being introduced in said groove.

5. The finger guard device as claimed in claim 1, wherein the fastening leg runs at least approximately perpendicularly to the supporting leg.

6. The finger guard device as claimed in claim 1, wherein the mounting profile has a connecting leg connecting the supporting leg and the fastening leg to each other.

7. The finger guard device as claimed in claim 6, wherein the connecting leg is arranged at an angle of greater than 90° with respect to the supporting leg and with respect to the fastening leg.

8. The finger guard device as claimed in claim 7, wherein the angle between the connecting leg and the supporting leg is approximately 135°, and the angle between the connecting leg and the fastening leg is approximately 135°.

9. The finger guard device as claimed in claim 1, wherein the fastening leg tapers toward a free end thereof and forms a hook receptacle.

10. The finger guard device as claimed in claim 9, wherein the hook receptacle forms a rectilinear and thinner extension of the fastening leg.

11. The finger guard device as claimed in claim 9, wherein the free end of the hook receptacle has a lug directed away from the supporting leg.

12. The finger guard device as claimed in claim 9, wherein a thicker part of the fastening leg forms a first slop surface and the hook receptacle forms a second stop surface for the fastening means.

13. The finger guard device as claimed in claim 9, wherein the fastening means surrounds the hook receptacle.

14. The finger guard device as claimed in claim 1, wherein the supporting leg has at least one recess for receiving a handlebar fastened to the door leaf.

15. The finger guard device as claimed in claim 1, wherein the supporting leg is provided such that a recess can be knocked out, milled, or produced therein by sawing, for receiving a handlebar fastened to the door leaf.

16. The finger guard device as claimed in claim 1, wherein the length of the mounting profile is formed in at least two pieces for arranging the mounting profile on an upper side and a lower side of a handlebar fastened to the leaf door, and wherein the roller blind web extends in one piece over an entire length of the mounting profile.

17. A mounting profile of a finger guard device as claimed in claim 1, wherein the mounting profile is in a form of an angular profile with a supporting leg and a fastening leg projecting to the supporting leg, for a releasable fastening of the fastening means the roller blind web.
